(19) United States
(12) Patent Application Publication
(10) Pub. No.: US 2005/0189775 A1
(43) Pub. Date: Sep. 1, 2005

(54) VEHICLE TRIM PANEL WITH INTEGRATED SEAL

(76) Inventor: Todd L. De Pue, Brighton, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/708,407

(22) Filed: Mar. 1, 2004

(51) Int. Cl. B60R 13/06

(52) U.S. Cl. 296/1.08

(57) ABSTRACT

A vehicle trim panel including an inner panel having an inner surface, an outer surface, and a perimeter edge generally extending around the inner and outer surfaces, the inner panel configured for attachment to a vehicle body and a flexible outer panel covering at least a portion of the outer surface of the inner panel and extending beyond the perimeter edge, the flexible outer panel configured to contact the vehicle body to reduce a gap between the inner panel and the vehicle body.

### FIELD OF THE INVENTION

The present invention relates generally to trim panels for vehicles and, more particularly, to gaps between trim panels and a vehicle body.

### BACKGROUND OF THE INVENTION

Trim panels are typically attached to a vehicle body, such as, for example, to the interior sides of doors and side walls, to present an aesthetically pleasing and/or ergonomic appearance to someone occupying the passenger compartment or using the vehicle. Further, and though many differently shaped trim panels exist, trim panels are often attached using U-nut, push-pin, or some other similar type of fasteners. Such fasteners are typically distributed around the periphery or over an inner surface of the trim panels so that the trim panels may be adequately attached to the vehicle body. Due to the types of fasteners used and the way the fasteners may be spaced over the inner surface of the trim panels, gaps commonly occur between the trim panels and the vehicle body. In addition, variations, e.g., tolerances, in the manufacture of the trim panels and/or the vehicle body may give rise to gaps between the trim panels and the vehicle body when the trim panels are attached to the vehicle body.

Gaps between trim panels and the vehicle body are undesirable for numerous reasons. First, gaps detract from the visual appearance of the passenger compartment of the vehicle, reducing the perceived quality or the fit and finish of the vehicle. Second, gaps allow the ingress of air, water or moisture, and road noise into the passenger compartment of the vehicle. Third, due to vibrations when the vehicle is being operated, trim panels tend to move with respect to the vehicle body generating noise, or what is commonly referred to as buzz, squeak, and rattle (BSR) noises. Gaps between trim panels and a vehicle body occur in automobiles, trucks, and aircraft.

One practice within the industry to prevent the ingress of air, water or moisture, and road noise into the passenger compartment of the vehicle is to adhesively attach a plastic film over any openings in the vehicle body prior to attaching the trim panel. While such an approach may prevent the ingress of air, water or moisture, and attenuate road noise in the passenger compartment of the vehicle, such an approach does nothing to improve the visual appearance of the gaps in passenger compartment of the vehicle or to reduce vibration and eliminate BSR.

Another practice within the industry to prevent the ingress of air, water or moisture, and road noise into the passenger compartment of the vehicle and to reduce vibration and eliminate BSR is to adhesively attach a seal around the outer edge of the trim panel that contacts the vehicle body prior to attaching the trim panel. While such an approach may prevent the ingress of air, water or moisture, attenuate road noise in the passenger compartment of the vehicle, and reducing vibration eliminating BSR, such an approach does little to improve the visual appearance of the gaps in the passenger compartment of the vehicle as the seal is generally visible once the trim panel is installed.

Yet another practice with the industry to reduce vibration and eliminate associated noise is to place a flat component made of open cell, low compression load deflection (CLD) foam between the trim panels and the vehicle body. Again, such an approach may prevent the ingress of air, water or moisture, and road noise into the passenger compartment of the vehicle and reduce vibration and eliminate BSR; however, such an approach also does little to improve the visual appearance of the gaps in the passenger compartment of the vehicle once the trim panel has been installed.

Moreover, such industry practices suffer common drawbacks. For instance, the use of a plastic film, a seal, or foam increases costs. Further, a plastic film, a seal, or foam must be placed between the trim panels and the vehicle body in assembly adding another step to the assembly process.

Therefore, there exists a need in the art for a vehicle trim panel that reduces the gap between the trim panel and a vehicle body thereby effectively preventing the ingress of air, water, moisture, and road noise and reducing BSR between the trim panel and a vehicle body without significantly increased cost or complicated assembly while providing an aesthetically pleasing appearance.

### SUMMARY OF INVENTION

In accordance with principles of the present invention, a vehicle trim panel includes an inner panel having an inner surface, an outer surface, and a perimeter edge generally extending around the inner and outer surfaces, the inner panel configured for attachment to a vehicle body and a flexible outer panel covering at least a portion of the outer surface of the inner panel and extending beyond the perimeter edge, the flexible outer panel configured to contact the vehicle body to reduce a gap between the inner panel and the vehicle body.

In another embodiment of the present invention, a vehicle includes a vehicle body and a vehicle trim panel, the vehicle trim panel including an inner surface, an outer surface, and a perimeter edge generally extending around the inner and outer surfaces, the inner panel configured for attachment to the vehicle body and a flexible outer panel covering at least a portion of the outer surface of the inner panel and extending beyond the perimeter edge, the flexible outer panel configured to contact the vehicle body to reduce a gap between the inner panel and the vehicle body.

In addition, the present invention further contemplates a method of reducing a gap between a vehicle trim panel having an outer surface and a vehicle body including depositing a flexible covering over at least a portion of the outer surface of the vehicle trim panel so that a portion of the flexible covering extends beyond an outer edge of the vehicle trim panel and positioning the portion of the flexible covering that extends beyond the outer edge of the vehicle trim panel against the vehicle body to reduce the gap between the vehicle trim panel and the vehicle body.

Various additional objectives, advantages, and features of the present invention will become more readily apparent to those of ordinary skill in the art from the accompanying drawings and description thereof.

### BRIEF DESCRIPTION OF DRAWINGS

FIG. 1 is a perspective view of a vehicle trim panel, constructed in accordance with principles of the present invention, fastened to a door of a vehicle body and illustrated in operational relationship to a vehicle; and

FIG. 2 is cross-sectional view of a portion of the vehicle trim panel and the vehicle body of FIG. 1 taken along line 2-2 of FIG. 1.

### DETAILED DESCRIPTION

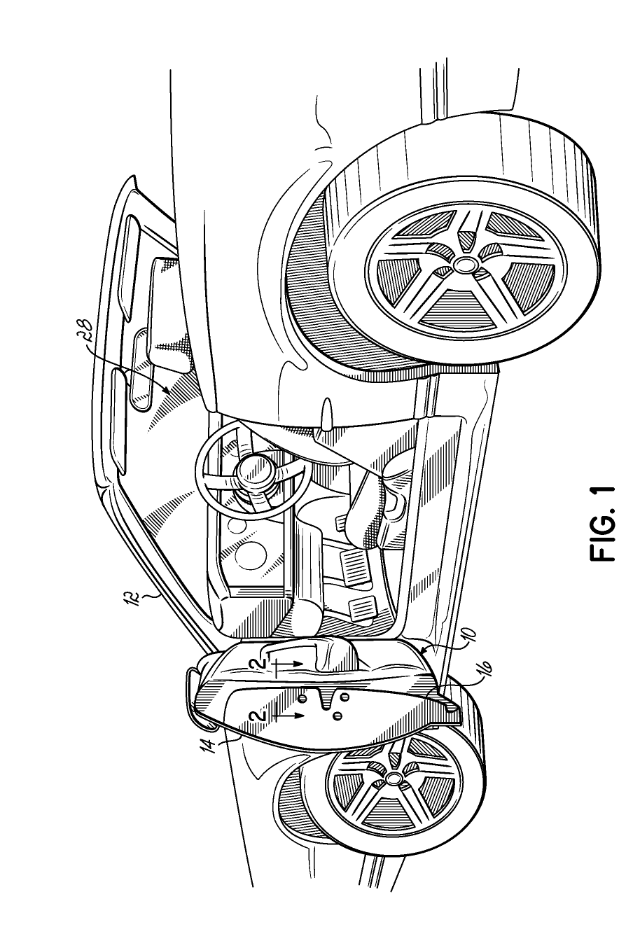

Referring first to FIG. 1, a vehicle trim panel 10 constructed in accordance with one embodiment of the invention is shown fastened to a vehicle body 12. A vehicle may be, for example, an automobile, a truck, or an aircraft. More specifically, trim panel 10 is shown fastened to an inner steel sheet metal panel 16 of a door 14 of vehicle body 12. However, those of ordinary skill in the art will appreciate that trim panel 10 may be used on other parts of the vehicle body 12 such as, for example, hatches, sidewalls, etc. Further, those of ordinary skill in the art will also appreciate that vehicle body 12 may be constructed of other materials such as, for example, aluminum, or a composite such as fiberglass or carbon fiber.

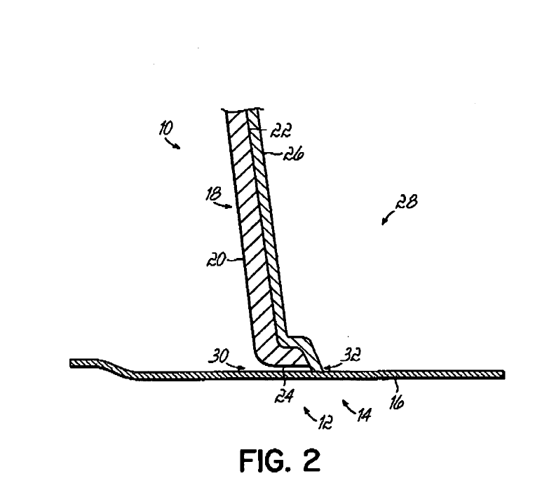

Referring also to FIG. 2, vehicle trim panel 10 comprises an inner panel 18 having an inner surface 20, an outer surface 22, and a perimeter edge 24 generally extending around the inner and outer surfaces 18, 20. Specifically, inner panel 18 is configured for attachment to vehicle body 12, such as to inner sheet metal panel 16 of door 14. More generally, vehicle trim panel 10 may be attached to vehicle body 12 using one or more fasteners (not shown). Further, fasteners may be distributed around the periphery or over inner surface 20 of inner panel 18 to adequately attach vehicle trim panel 10 to door 14. Fasteners may be U-nut, push-pin or “Christmas tree” type fasteners, or some other similar type of fasteners.

Vehicle trim panel 10 further comprises a flexible outer panel 26 covering at least a portion of the outer surface 22 of the inner panel 18. As illustrated, flexible outer panel 26 extends beyond the perimeter edge 24 of inner panel 18, as shown at reference numeral 32, and is configured to contact the vehicle body 12, e.g., inner sheet metal panel 16 of door 14, to reduce a gap 30 between the inner panel 18 and the vehicle body 12.

Such a contacting of flexible outer panel 26 with inner sheet metal panel 16 of door 14 of vehicle body 12 reducing gap 30 between the inner panel 18 and the vehicle body 12 effectively prevents the ingress of air, water, moisture, and road noise into passenger compartment 28. Buzz, squeak, and rattle (BSR) between vehicle trim panel 10 and vehicle body 12 is also effectively reduced without significantly increased cost or complicated assembly. Those of ordinary skill in the art will appreciate that BSR refers not only to buzz, squeak, and rattle noises between a vehicle trim panel and a vehicle body but to noise, vibration and hardness (NVH) issues as well. Thus, BSR, as used herein, refers to all noises occurring between a vehicle trim panel and a vehicle body. In addition, flexible outer panel 26 provides an aesthetically pleasing appearance, as there is no discontinuity in materials as with a seal.

In accordance with another aspect, the present invention further contemplates a method of reducing gap 30 between trim panel 10 having an outer surface 22 and vehicle body 12. The method includes depositing a flexible covering, e.g., flexible outer panel 26, over at least a portion of outer surface 22 of trim panel 10 so that a portion 32 of the flexible covering 26 extends beyond an outer edge 24 of trim panel 10. The method further includes positioning the portion 32 of flexible covering 26 that extends beyond the outer edge 24 of trim panel 10 against vehicle body 12 to reduce gap 30 between trim panel 10 and vehicle body 12.

The depositing of flexible outer panel 26 over at least a portion of outer surface 22 of trim panel 10 may be performed using a molding process. For example, in one embodiment of the invention, a conventional insert molding process may be used. In a preferred embodiment of the invention, a two shot molding process within a press as is known in the art is used.

Further, when a two shot molding process is used, flexible outer panel 26 may be formed of a thermoplastic elastomer (TPE), whereas inner panel 18 may be formed of a thermoplastic olefin (TPO) or polypropylene (PP). When TPO or PP is used for inner panel 18, inner panel 18 gives rigidity to vehicle trim panel 10. Similarly, when TPE is used for flexible outer panel 26 a flexible outer covering is deposited or molded onto outer surface 22 of inner panel 18 that gives the surface of vehicle trim panel 10 exposed to passenger compartment 28 a generally soft touch that yields under pressure. Thus, flexible outer panel 26 extending beyond perimeter edge 24 of inner panel 18 is particularly suited to reducing gap 30 between inner panel 18 and vehicle body 12.

While the present invention has been illustrated by a description of a preferred embodiment and while this embodiment has been described in some detail, it is not the intention of the Applicants to restrict or in any way limit the scope of the appended claims to such detail. Additional advantages and modifications other than those specifically mentioned herein will readily appear to those skilled in the art. This has been a description of the present invention, along with the preferred methods of practicing the present invention as currently known. However, the invention itself should only be defined by the appended claims, wherein I claim:

1. A vehicle trim panel, comprising:
an inner panel having a first flexibility and having an inner surface, an outer surface, and a perimeter edge having an exposed surface generally extending around the inner and outer surfaces, the inner panel configured for attachment to a vehicle body such that the exposed surface is spaced apart from the vehicle body to define a gap between the inner panel and the vehicle body when so attached; and
an outer panel having a second flexibility greater than the first flexibility covering at least a portion of the outer surface of the inner panel and extending beyond the perimeter edge, the outer panel configured to contact the vehicle body when the inner panel is attached to the vehicle body so as to close the gap between the inner panel and the vehicle body and thereby prevent or reduce the Ingress of air, moisture or noise into a vehicle passenger compartment.

2. The vehicle trim panel of claim 1, wherein the inner panel and the outer panel are molded together.

3. The vehicle trim panel of claim 2, wherein the inner panel is molded from one of thermoplastic olefin (TPO) or polypropylene (PP).

4. The vehicle trim panel of claim 2, wherein the outer panel is molded from a thermoplastic elastomer (TPE).

5. The vehicle trim panel of claim 2, wherein the inner panel and the outer panel are molded together using a two shot molding process.

6. A vehicle, comprising:
a vehicle body;
a vehicle trim panel, the vehicle trim panel including an Inner panel having a first flexibility and having an inner surface, an outer surface, and a perimeter edge having an exposed surface generally extending around the inner and outer surfaces, the inner panel attached to the vehicle body such that the exposed surface is spaced apart from the vehicle body to define a gap between the inner panel and the vehicle body; and
an outer panel having a second flexibility greater than the first flexibility covering at least a portion of the outer surface of the inner panel and extending beyond the perimeter edge, the outer panel contacting the vehicle body so as to close the gap between the Inner panel and the vehicle body and thereby prevent or reduce the ingress of air, moisture or noise into a vehicle passenger compartment.

7. The vehicle claim 6, wherein the inner panel and the outer panel are molded together.

8. The vehicle of claim 7, wherein the inner panel is molded from one of thermoplastic olefin (TPO) or polypropylene (PP).

9. The vehicle trim claim 7, wherein the outer panel is molded from a thermoplastic elastomer (TPE).

10. The vehicle trim panel of claim 7, wherein the inner panel and the outer panel are molded together using a two shot molding process.

11. A method of reducing a gap between a vehicle trim panel having an outer surface and a vehicle body comprising:
depositing a covering having a first flexibility over at least a portion of the outer surface of the vehicle trim panel having a second flexibility less than the first flexibility so that a portion of the covering extends beyond an outer exposed edge of the vehicle trim panel; and
positioning the portion of the covering that extends beyond the outer exposed edge of the vehicle trim panel against the vehicle body to reduce the gap between the vehicle trim panel and the vehicle body.

12. The method of claim 11, wherein the covering is deposited in a molding process.

13. The method of claim 11 further comprising, molding the trim panel from one of thermoplastic olefin (TPO) or polypropylene (PP).

14. The method of claim 11 further comprising, molding the covering from a thermoplastic elastomer (TPE).

15. The method of claim 11 further comprising, molding the trim panel and the covering together in a two shot molding process.
